(19) United States
(12) Patent Application Publication
(10) Pub. No.: US 2010/0228610 A1
(43) Pub. Date: Sep. 9, 2010

(54) ADDING TEXT OR GRAPHICS TO AN ADVERTISEMENT USING DTV CLOSED CAPTIONING

(76) Inventor: Ilan Kaftan, Los Altos, CA (US)

Correspondence Address: WALL & TONG, LLP/;ALCATEL-LUCENT USA INC., 595 SHREWSBURY AVENUE, SHREWSBURY, NJ, 07702, US

(21) Appl. No.: 12/397,363

(22) Filed: Mar. 4, 2009

(51) Int. Cl. H04N 7/025; H04N 7/173; H04N 7/08; G06Q 30/00

(52) U.S. Cl. 705/14.4; 725/32; 725/110; 348/468; 348/E07.001

(57) ABSTRACT

A mechanism to controllability overlay text and/or graphics over advertisements within the context of a DTV system using a closed captioning (CC) processing ability of set-top boxes within the DTV system.

### FIELD OF THE INVENTION

The present invention relates to television systems in general and, more particularly, to the presentation of text-based advertising within the context of a digital television.

### BACKGROUND

Local advertising may be inserted into a digital television (DTV) signal by replacing national advertising within the DTV signal using a splicing mechanism. In this manner, an encoded local advertising stream replaces encoded national advertising stream without the complexity of decoding either stream. However, to overlay text and/or graphics onto an advertising stream or other DTV content stream it is necessary to decode and (if necessary) decrypt the stream to an elementary stream level. The text and/or graphics are then overlaid using standard baseband video processing techniques. These techniques typically require dedicated digital signal processing (DSP) code within, for example, a splicing device such as that used to insert local advertising. A known solution to this problem is the use of a splicer that provides rate shaping functions and is capable of performing such processing at the discrete cosine transform (DCT) level to create new video frames comprising original video frames overlaid with text and/or graphics.

### BRIEF SUMMARY

Various deficiencies of the prior art are addressed by the present embodiments of a mechanism to controllability overlay text and/or graphics over advertisements within the context of a DTV system using a closed captioning (CC) processing ability of set-top boxes within the DTV system.

One embodiment comprises a method for use in a digital television (DTV) system, comprising: associating an advertisement with text-based information; transmitting the advertisement toward one or more set-top boxes; and transmitting the text-based information toward the one or more set-top boxes, wherein the text-based information is adapted to be processed by a closed captioning (CC) system to provide thereby a text overlay of the advertisement.

One server side embodiment is an apparatus for use in a digital television (DTV) system, the apparatus including a combiner, for associating text-based information with a content stream including advertisements.

One client side embodiment is an apparatus for use in a digital television (DTV) system, the apparatus including a transport demultiplexer, for demultiplexing a transport stream to provide thereby a program stream; a parser, for parsing the program stream to extract therefrom a compressed audiovisual stream and user data including closed captioning (CC) data; a decoder, for decoding the compressed audiovisual stream to provide thereby a video stream; and a video combiner, for overlaying the CC data onto the video stream.

### BRIEF DESCRIPTION OF THE DRAWINGS

The teachings of the present invention can be readily understood by considering the following detailed description in conjunction with the accompanying drawings, in which:

FIG. 1 depicts a high level block diagram of a digital television (DTV) closed captioning (CC) decoding system according to one embodiment;

FIG. 2 depicts a high level block diagram of a client-side processing method according to an embodiment; and

FIG. 3 depicts a high-level block diagram of a system according to one embodiment.

To facilitate understanding, identical reference numerals have been used, where possible, to designate identical elements that are common to the figures.

### DETAILED DESCRIPTION OF THE INVENTION

Embodiments of the invention will be primarily described within the context of a mechanism to controllability overlay text and/or graphics over advertisements within the context of a digital television (DTV) system using a closed captioning (CC) processing ability of set-top boxes within the DTV system. However, those skilled in the art and informed by the teachings herein will realize that the invention is also applicable to overlaying any type of content with text and/or graphics using the CC processing ability of the set-top box.

The present embodiments are primarily described within the context of digital television closed captioning (DTVCC) according to the Consumer Electronics Association Standard denoted as CEA-708-C, which is incorporated herein by reference in its entirety. The CEA-708-C allows 9600 bps of data to be transmitted as part of the transport layer. This data is detected by the STB and presented on a presentation device such as a monitor using the defined fonts and screen location as indicated by the standard. This information is inserted during, illustratively, local advertising or other opportunities in conjunction with a trigger signal or message adapted to enable a closed captioning functionality within a set-top box.

It is assumed that CC data and auxiliary/ancillary data discussed within the context of the present embodiments generally conforms to the descriptions provided in the CEA-708-C document and any supplemental description provided herein. It is noted that other closed captioning standards, techniques, systems and/or methodologies may be adapted in conformance with the various embodiments discussed herein. Generally speaking, the various embodiments utilize the underlying CC processing capability of a client device (irrespective of the standard or technique employed) to insert text-based advertising into a video stream intended for presentation.

While described within the context of text-based advertising, it should be noted that the actual content of the text is not necessarily advertising. That is, the DTVCC systems described herein are adapted to enable coordinated or triggered insertion/overlay of text upon a video signal. The video signal may include advertising that can be more specifically targeted to the user (or user neighborhood, region etc.) by coordinated triggering of the text overlay. Emergency information may also be conveyed. Generally speaking, advertising and/or non-advertising video content may be overlayed with advertising and/or non-advertising text within the context of the various embodiments.

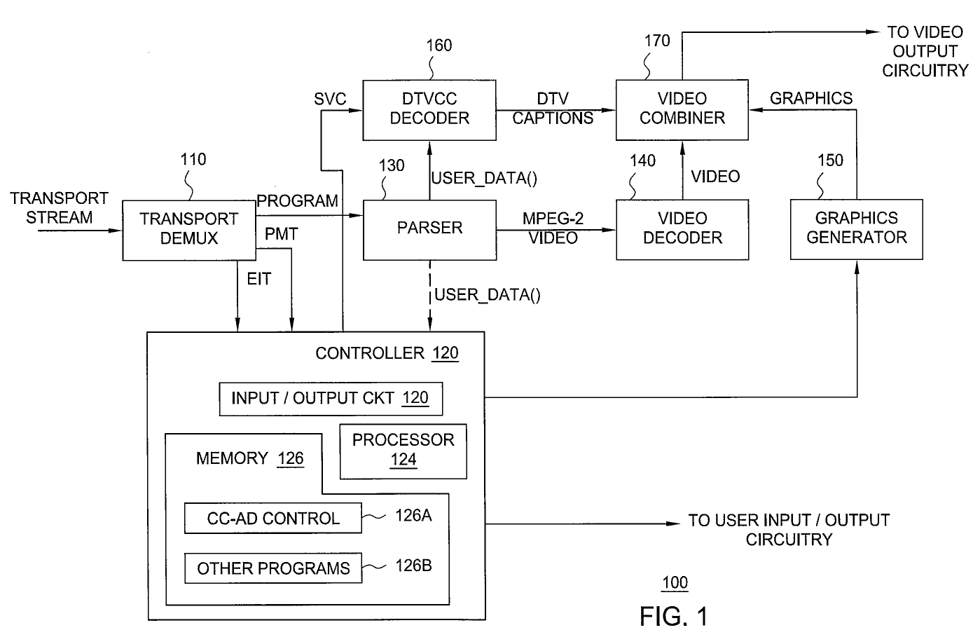

FIG. 1 depicts a high level block diagram of a digital television (DTV) closed captioning (CC) decoding system according to one embodiment. Specifically, the system 100 of FIG. 1 comprises relevant portions of a client device adapted to receive and process video, audio, closed caption (CC) and other data within the context of a digital television (DTV) system. The DTV system comprises, illustratively, a DTV system conforming to the various MPEG-2 standards. Other DTV systems (e.g., the European DVB system, MPEG-4 or other MPEG systems and so on) may also be used within the context of the present embodiments.

Generally speaking, the system operates to select or demultiplex one or more transport encoded streams to extract therefrom desired audiovisual and associated data streams. The system processes the extracted streams to provide output video and audio streams suitable for use by a presentation device, such as a display device and audio system (e.g., a television). It is noted that the audio processing portions of the system are omitted for clarity.

The system 100 of FIG. 1 comprises a transport demultiplexer 110, a controller 120, a parser 130, a video decoder 140, a graphics generator 150, a digital television closed caption (DTVCC) decoder 160 and a video combiner 160.

The demultiplexer 110 operates to selectively demultiplex one or more transport encoded programming streams TRANSPORT STREAMS to provide thereby a corresponding program stream PROGRAM including a video stream, audio stream, and/or data streams such as a program map table (PMT) data stream, event information table (EIT) data stream, and any other ancillary/auxiliary data streams. The program stream PROGRAM is provided to the Parser 130. The PMT, EIT and other data streams (not shown) are provided directly to the controller 120. Optionally, some or all of the PMT, EIT and/or other data streams may be provided to the parser 140 for processing (e.g., as part of the program stream PROGRAM).

The parser 130 parses the program stream PROGRAM to separate at least MPEG-2 video data portions and user_data( ) portions of the demultiplexed program stream. The parsed MPEG-2 video data is provided to and decoded by the video decoder 140 to provide a baseband video stream VIDEO, which is coupled to the video combiner 170. The parsed user_data( ) is coupled to the DTVCC decoder 150 and, optionally, the controller 120.

The DTVCC decoder operates to selectively provide DTV captions to the video combiner 170 in response to a service signal SVC signal provided by the controller 120 and/or the user_data( ) provided by the parser 130. In one mode of operation, no displayable data (i.e., no data or blank data) is provided to the video combiner 170. In this case, the ultimate video presentation will not include CC related imagery. In another mode of operation, “standard” CC data such as subtitles and the like is provided to the video combiner 170. In another mode of operation, text-based advertising is provided to the video combiner 170. The text-based advertising may be delivered to the DTVCC decoder via the video parser 130 via the user_data( ) signal path or via the controller 120 via the SVC signal path.

The graphics generator 150 is responsive to the controller 120 to generate graphic layer imagery such as (illustratively) graphical user interface (GUI) screens, which imagery is coupled to the video combiner 170.

The video combiner 170 operates to combine the decoded video signal VIDEO, the graphics signal GRAPHICS (if present) and the DTV captions (if present) to produce an output video signal for subsequent processing by video output circuitry (not shown). The output video circuitry is adapted to provide a video signal in a format suitable for use by a presentation device (not shown), such as a television, computer monitor or other display device.

The controller 120 comprises input/output (I/O) circuitry 122, at least one processor 124, various support circuitry (not shown) and memory 126. The memory includes programs such as a closed caption advertising control program 126A as well as other programs 126B. The at least one processor 124 may be any conventional processor for executing programs stored in the memory 126. The memory may be any conventional volatile memory (e.g., RAM, DRAM, among others), non-volatile memory (e.g., disk drives, floppy, drives, CDROM, EPROMS, among other computer readable medium) or any other conventional memory device for storing data and various control programs, such as methodology according to the present embodiments.

The processor 124 cooperates with conventional support circuitry, such as power supplies, clock circuits, cache memory and the like, as well as circuits that assist in executing the various programs and routines, as well as other programs and data. As such, it is contemplated that some of the process steps discussed herein as software processes may be implemented within hardware, for example, as circuitry that cooperates with the processor to perform various steps. The input/output (I/O) circuitry 122 forms an interface between the various functional elements communicating with each network element.

Although the controller 120 described herein is depicted as a general-purpose computer that is programmed to perform various control functions in accordance with the present embodiments, the embodiments can be implemented in hardware such as, for example, an application specific integrated circuit (ASIC). As such, it is intended that the processes described herein be broadly interpreted as being equivalently performed by software, hardware, or a combination thereof.

The various embodiments may be implemented as a computer program product wherein computer instructions, when processed by a computer, adapt the operation of the computer such that the methods and/or techniques of the present embodiments are invoked or otherwise provided. Instructions for invoking the inventive methods may be stored in fixed or removable media, transmitted via a data stream in a signal bearing medium such as a broadcast medium, and/or stored within a working memory within a computing device operating according to the instructions.

The controller 120 in one mode of operation interacts with user input/output circuitry and/or devices (not shown) to provide interactive control of the client device to a user. Visual information associated with such interactive control is provided to the user via the graphics generator 155.

The controller in one mode of operation determines whether the parsed video signal is associated with a content stream or an advertising stream. If an advertisement stream, the controller 120 then determines if a text-based advertisement is associated with the advertisement stream. If so, then the text-based advertisement is provided to the video combiner 170 via the DTVCC decoder at a time contemporaneous with the decoded video stream VIDEO. In this manner, text-based advertising is used to augment standard advertising.

In one embodiment, the video-based advertising is directed to a national or regional product/service, and the contemporaneously displayed text-based advertising comprises local vendor information associated with the advertised product/service. In other embodiments, the text-based advertising comprises any of a street address, an internet address, a local pricing scheme associated with the product, a telephone number and so on. It should be noted that while the text-based advertising is generally more useful when associated with the video-based advertising, such an association is not necessary to practice the various embodiments.

The determination of whether a parsed video stream comprises an advertisement stream or a content stream is made by either of both of the parser 130 or controller 120. For example, in one embodiment the parser 130 monitors the program stream and, in response to a determination that an advertisement is presently being processed, adapts information within the stream (e.g., a flag within a user_data( ) field) to indicate that an advertisement is present. The user_data( ) field is provided to the DTVCC decoder 160 and, optionally, the controller 120. In another embodiment, the controller 120 processes the PMT to determine whether an advertisement if presently scheduled, or data provided by the parser 130 to determine whether an advertisement is presently being parsed. In response, the controller causes the graphics generator 150 to provide graphics imagery to the video combiner 170.

In one embodiment, advertising-related text is included within a user_data( ) portion of a demultiplexed stream only during the time that the demultiplexed stream is associated with advertising video.

In one embodiment, a flag is used to indicate whether advertising text is present (or absent) such that the DTVCC may be directed to provide (or stop providing) text-based advertising to the video combiner. The flag is included in any suitable portion of the data stream(s) processed by the system 100 of FIG. 1, such as the user_data( ) portion of a stream, a PMT or EIT portion, an auxiliary data portion and so on.

In one embodiment, a determination is made as to whether the on-screen position associated with the text-based advertising conflicts with an on-screen position associated with other CC data (e.g., subtitles). In this case, the position of one or both of the text-based advertising and other CC data is adapted.

In one embodiment, the text-based advertising is provided in multiple languages. In this embodiment, text-based advertising data of an appropriate language is displayed. The determination of the appropriate language is made using one or more of a user preference setting, a separate audio program (SAP setting, a CC language selection setting and the like.

In various embodiments, a signal operative to enable or disable CC processing by client devices such as set top boxes is provided within the data transported to the client devices. The enable or trigger signal comprises a flag within a user_data( ) field, a specific command and the like. For example, in one embodiment, each inserted CC is preceded by a specific CC-enable signal and followed by a corresponding CC-disable signal such that the client device responsively activates or deactivates CC processing circuitry associated with the inserted CC advertising

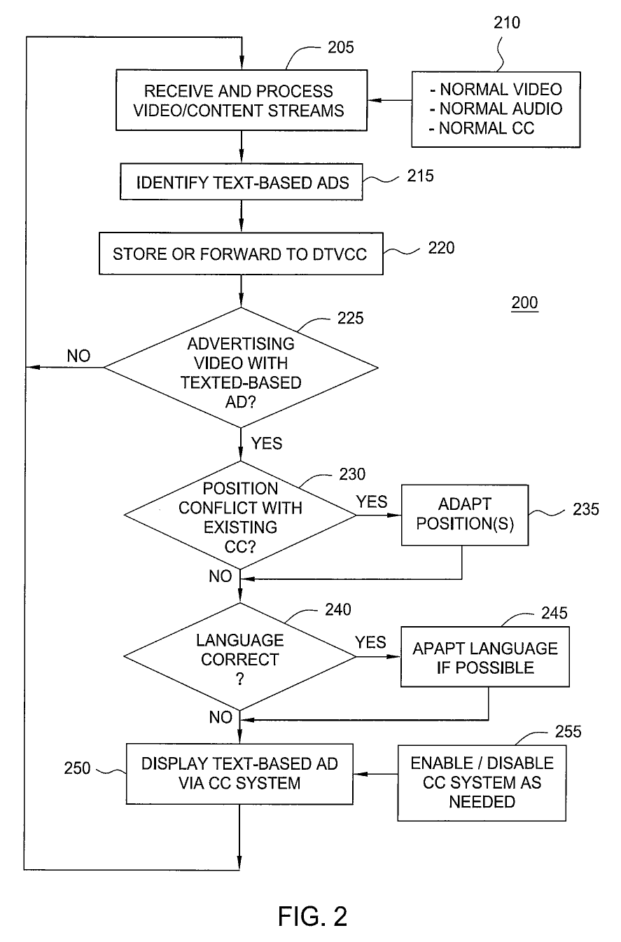

FIG. 2 depicts a high level block diagram of a client-side processing method according to an embodiment. Specifically, the method 200 of FIG. 2 is entered at step 205 when the client device receives and processes audiovisual streams such as content streams and advertising streams. The audiovisual streams typically include a video stream, at least one audio stream and one or more closed captioning (CC) data streams to enable subtitles in one or more languages. Referring to box 210, the processing of step 205 occurs in a substantially standard manner wherein the received audiovisual streams are decoded to provide normal video, normal audio and normal CC functionality. If the CC function of the client device is enabled, then CC data associated with a selected CC data stream is also decoded and included within the video representative signal to be used by the presentation device. Such a “normal” CC data stream may include subtitles and so on. Optionally, the client device enables CC processing in response to a CC enable signal such as discussed above with respect to FIG. 1.

At step 215, text-based advertising provided within the demultiplexer stream is identified. At step 220, the identified text-based advertising is stored (e.g., in the memory 126 of controller 120) or forwarded to a CC processor (e.g., DTVCC decoder 160).

At step 220, a determination is made as to whether an active video advertisement (i.e., a video advertisement currently being presented) is associated with the identified text-based advertisement. If no associated active video, then the method 200 returns to step 205.

At step 230, a determination is made as to whether a position conflict exists between the identified text-based advertising and an existing CC display. If a conflict exists, then at step 235 the conflict is resolved by adapting the position of one or both of the text-based advertisement and the existing CC text.

At step 240, a determination is made as to whether the language associated with the text-based advertising is correct. This determination is made using any of a selected user preference, a selected SAP indicator and so on as described above.

If the language of the text-based advertisement is incorrect, then at step 245 the language of the text-based advertisement is adapted or corrected if possible. The correction may comprise a substitution of a different text-based advertisement and/or the translation of the text-based advertisement.

At step 250, the text-based advertisement (adapted or unadapted) is displayed via the CC system (e.g., provided by the DTVCC 160 to the video combiner 170 for inclusion within an output video stream or signal). Referring to box 255, the CC system is enabled and disabled as needed. In various embodiments the CC system is enabled and disabled based upon the presence or absence of text-based advertising associated with a presently displayed advertisement. In other embodiments, the CC system is enabled and disabled based upon a trigger signal received via the network. The trigger signal may be in-band or out-of-band, and may be provided via any upstream network element.

As previously noted, in one of mode of operation, a trigger or enable signal is transmitted to the client device to trigger thereby the display of text-based advertising. That is, a head-end or other upstream network element provides a trigger signal adapted to cause local insertion/display of the text-based advertising at an appropriate time using local CC processing mechanisms. Similarly, another trigger signal is sent to cause a cessation of local insertion/display of the text-based advertising. In another embodiment, the packet id (PID) associated with a CC data bearing stream or portion thereof is used to indicate to the client device that the stream or stream portion includes overlay text for local insertion.

The trigger signal comprises an in-band trigger in one embodiment and an out-of-band trigger in another embodiment. In either mode of operation, trigger signals are forwarded to the one or more set-top boxes at a time contemporaneous splice points associated with the inserted or local advertisements, such as advertisements within the broadcast content streams. In one embodiment, a plurality of advertisements and CC-enabling trigger signals are forwarded to one or more set-top boxes just after the occurrence of a splice-in point within a broadcast content stream. Optionally, a plurality of CC-disabling trigger signals are forwarded to the one or more set-top boxes just after the occurrence of a splice-out point within the broadcast content stream. The trigger signals may be included in standard control messages, as flags within various data fields such as user_data( ) fields and so on.

Text and/or graphics data to be presented via the CC system a set-top box is initially stored in a splicer or combiner, or received from a server along with a corresponding advertisement.

In one embodiment, advertising has been spliced into a broadcast stream for delivery to one of more set-top boxes. In addition to this advertising (which may be national or regional in scope), individual setup boxes, neighborhoods of set-top boxes and the like may be associated with additional text-based advertising. The text-based advertising may be related to the inserted advertising, such as text providing contact information to a local dealer of a product or service described within the inserted advertising.

In one embodiment, a determination is made as to whether other text is being subjected to closed-captioned processing by a set-top box (e.g., subtitles in a different language). In this embodiment, position information associated with the text-based advertising is modified such that the closed-captioned processing of the text-based advertising results in the presentation of the text-based advertising at a screen/display position different from that used for the other text. In one embodiment, a default display position for text-based advertising is selected to generally differ from the usual set-top box default closed-captioned display positions.

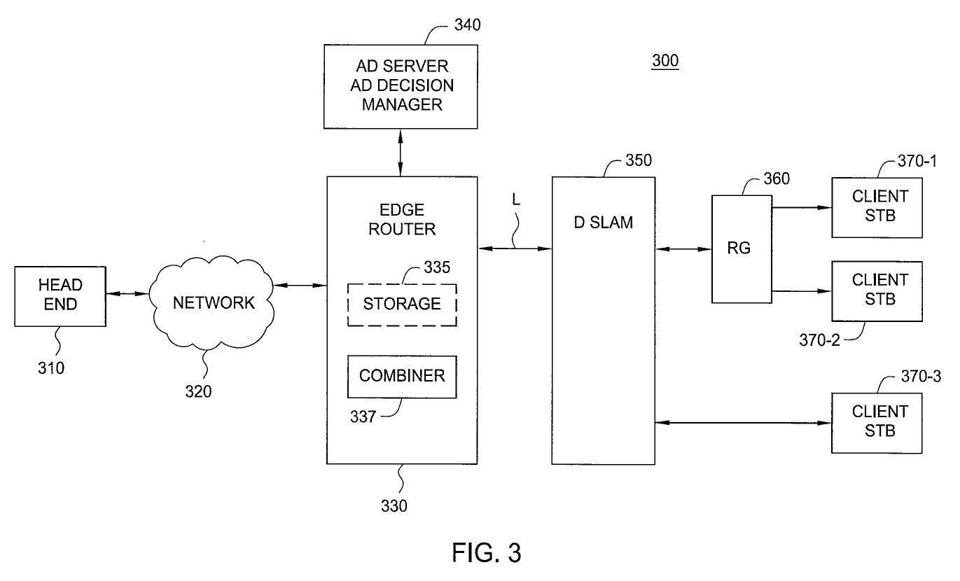

FIG. 3 depicts a high-level block diagram of a system according to one embodiment. Specifically, the system 300 of FIG. 3 comprises a head end 310, a network 320, at least one edge router 330 (e.g., a switch), an advertisement server/decision manager 340, at least one access node 350 (e.g., a DSLAM), an optional residential gateway (RG) 360 and a plurality of client set-top boxes denoted as 370-1 through 370-3 (collectively client STBs 370).

Generally speaking, multicast and/or unicast content streams are provided by the head end 310 to the client set-top boxes 370. The content streams may be broadcast to multiple clients or narrowcast to specific/requesting clients. Thus, a content stream provided by the head end 310 traverses the network 320, the edge router 330, the access node 350 and, optionally, the RG 360 before being received by a client STB 370.

The content streams provided by the head end include default advertising as discussed above. The advertising may be provided in 30 second, 60 second or other time increments. Each portion of a content stream including default advertising is delineated by input and output splice points. In this manner, local, regional, targeted/addressable and/or client requested advertising may be spliced into the content stream delivered to a client in a substantially seamless manner.

Advertising content (e.g., audiovisual advertising content) to be spliced into a content stream is stored in the advertisement server/decision manager 340. A storage device 335 operating as an advertising server is optionally included within the edge router 330. In one embodiment, storage device 335 receives from advertising server 340 those advertising streams intended for presentation at the STBs 370 associated with the respective edge router. In another embodiment, storage device 335 receives advertising streams provided by a remote advertising server (not shown) via the network 320. Generally speaking, the advertising streams may be stored in any storage device accessible to a network element such as a router or other splicing mechanism operating in accordance with the various embodiments.

The edge router 330 includes a splicer/combiner 337 operative to splice multicast and/or unicast streams as also discussed herein. The edge router 330 communicates multicast and/or unicast streams to the access node 350 via a communications link L. The access node selectively communicates either a multicast stream or a unicast stream to each client STB 370.

In normal operation a multicast stream including, for example, a network feed or other program including default advertising is received from the network 320 by the edge router 330 and forwarded via the access node 350 to multiple client devices 370 for decoding a presentation. The multicast stream is characterized by a particular packet id structure, particular group of pictures structure, particular bit rate and so on.

Audiovisual-Based Advertising Insertion.

In one embodiment, the system 300 FIG. 3 operates to selectively insert new or different audiovisual advertising content into content stream in place of default audiovisual advertising content within that content stream. In one embodiment, the multicast stream itself may be modified to include the new advertising content. In another embodiment, a unicast stream including the new advertising content is transmitted to the appropriate set-top boxes. In either the multicast or unicast case, default advertising is delivered to the appropriate set-top boxes. In one embodiment, the multicast and unicast streams have the same address such that the transition from one to the other at the client device is made without a reselection/requisition process. In this embodiment, the client device (e.g., set top box) treats the unicast stream in the same manner as the multicast stream, thereby facilitating a rapid transition between streams.

Audiovisual-based advertising streams may be preloaded or stored in a splicing entity (e.g., a router, switch or other device performing the splicing operation). Audiovisual-based advertising streams may also be stored in advertising servers or remote servers as needed.

Text-Based Advertising Insertion.

Text-based and/or other overlay data compatible with a set-top box closed captioning system may be combined with default advertising content and/or new advertising content (i.e., advertising content used to replace default advertising content). Generally speaking, the CC-compatible data combined with advertising includes information related to such advertising, such as local contact information and the like. Other information may also be conveyed by the CC-compatible data.

In one embodiment, the CC-compatible data is inserted into a private data field associated with a default or new advertising content stream. That is, the specific advertising content stream to which the CC-compatible data is related is modified to include the CC-compatible data in a private data field or other field. In this embodiment, the CC-compatible data is extracted from the advertising content stream by the set-top box for subsequent processing by the closed caption processing system.

In another embodiment, the CC-compatible data is inserted into a stream having a packet ID different than the corresponding advertising content stream. That is, the CC-compatible data is associated with a stream having a unique packet ID (i.e., a separate data bearing stream). In this embodiment, the CC-compatible data is extracted by the set-top box from the data bearing stream according to the unique packet ID associated with the data bearing stream. The extracted data is then processed by the closed caption processing system of the set-top box.

A CC-enable trigger signal is propagated to the appropriate set-top boxes to ensure that the closed caption processing systems of the set-top boxes are enabled. The CC-enable trigger signal may be inserted within an advertising content stream or included within a separate data bearing stream. The trigger signal operates to enable the closed caption processing system of the set-top box so that the text-based and/or other overlay data is presented via a set-top box.

A CC-disable trigger signal is propagated to the appropriate set-top boxes to disable (if necessary) the closed caption processing systems of the set-top boxes. The CC-disable trigger signal may be inserted within an advertising content stream or included within a separate data bearing stream.

In one embodiment, set-top boxes include additional resident software adapted for interpreting the CC-enable and a CC-disable trigger signals. In operation, the resident software when executed ensures that the trigger signals are properly interpreted such that the closed caption processing systems are appropriately enabled or disabled. No embodiments, the resident software when executed ensures that use of the closed captioning systems within the context of text-based advertising does not interfere with existing use of the closed captioning systems, such as providing subtitles for a television program has previously discussed.

In one embodiment, SCTE-35 signaling is used to delineate advertising stream boundaries. In this embodiment, the SCTE-35 signaling is also used to delineate CC-enable and CC-disable trigger signal points. That is, a SCTE-35 signaling point associated with the start of an advertisement is further associated with a CC-enable trigger signal. A further embodiment, a SCTE-35 signaling point associated with the end of an advertisement is further associated with a CC-disable trigger signal.

An apparatus according to one embodiment for use in an Internet protocol television (IPTV) system comprises a server, for associating text-based advertising into an advertising stream transmitted toward the client device, where the text-based advertising is configured to be processed by closed captioning systems within the client device.

The various embodiments advantageously provide a less complicated mechanism for implementing text-based advertising within a context of a digital television (DTV) system. That is, rather than using video-baseband processing techniques, the various embodiments utilizing existing closed captioning circuitry/functionality to implement the text-based advertising. The addition of a triggering mechanism to enable/disable the closed-captioned processing function of the set-top box is easily accomplished via upgrading set-top box software or adding a new application to a set-top box middleware platform. In one embodiment, service providers maintain control of the closed-captioned function within each of the set-top boxes they serve. In this embodiment, service providers maintain the ability to enable or disable closed-captioned processing of text within a specific portion of the screen such that a revenue-generating text-based advertising offering may be provided.

While the foregoing is directed to various embodiments of the present invention, other and further embodiments of the invention may be devised without departing from the basic scope thereof. As such, the appropriate scope of the invention is to be determined according to the claims, which follow.

What is claimed is:

1. A method for use in a digital television (DTV) system, comprising:
associating an advertisement with text-based information;
transmitting the advertisement toward one or more set-top boxes; and
transmitting the text-based information toward the one or more set-top boxes, wherein the text-based information is adapted to be processed by a closed captioning (CC) system to provide thereby a text overlay of the advertisement.

2. The method of claim 1, further comprising transmitting toward the one or more set-top boxes a CC enable signal, the CC enable signal adapted to enable CC processing of the text-based information by the one or more set-top boxes.

3. The method of claim 2, further comprising transmitting toward the one or more set-top boxes a CC disable signal, the CC disable signal adapted to disable CC processing of the text-based information by the one or more set-top boxes.

4. The method of claim 1, further comprising adapting a presentation position of the text-based information in response to a determination that other information is being processed by a CC processing system of a set-top box.

5. The method of claim 4, wherein said determining comprises determining whether a subtitle display is enabled.

6. The method of claim 3, wherein the CC enable signal is transmitted contemporaneously with a beginning portion of said advertisement, and the CC disable signal is transmitted contemporaneously with an ending portion of said advertisement.

7. The method of claim 1, wherein the text-based information is related to an advertised product or service.

8. The method of claim 7, wherein the text-based information comprises vendor information associated with the advertised product or service.

9. The method of claim 8, wherein the local vendor information comprises one or more of a street address, an internet address, a local pricing scheme associated with the product and a telephone number of the vendor.

10. An apparatus for use in a digital television (DTV) system, comprising:
a combiner, for associating text-based information with a content stream including advertisements.

11. The apparatus of claim 10, wherein the apparatus comprises an edge router.

12. The apparatus of claim 10, wherein:
the combiner is adapted to replace existing advertisements within a content stream with new advertisements.

13. The apparatus of claim 10, wherein the combiner replaces existing advertisements within a content stream in response to an SCTE-35 control signal.

14. The apparatus of claim 10, wherein the combiner receives the new advertising content from a storage device.

15. The apparatus of claim 10, wherein the text-based information is associated with a content stream by inserting the text-based information into a user data field associated with the content stream.

16. The apparatus of claim 10, wherein the text-based information is associated with a content stream by associated a predefined packet identifier (PID) with packets bearing the text-based information.

17. An apparatus, comprising:
a transport demultiplexer, for demultiplexing a transport stream to provide thereby a program stream;
a parser, for parsing the program stream to extract therefrom a compressed audiovisual stream and user data including closed captioning (CC) data;
a decoder, for decoding the compressed audiovisual stream to provide thereby a video stream; and
a video combiner, for overlaying the CC data onto the video stream.

18. The apparatus of claim 17, wherein the user data including closed captioning (CC) data is encoded, the apparatus further comprising a digital television closed caption (DTVCC) decoder, for decoding the encoded user data to provide thereby the CC data.

19. The apparatus of claim 17, further comprising a controller, for causing the DTVCC decoder to process the encoded user data in response to a determination that the program stream includes an advertisement associated with the respective CC data.

20. The apparatus of claim 19, wherein the controller processes at least one of user data, a program map table and an event information table to determine whether the program stream includes an advertisement

21. The apparatus of claim 17, further comprising a graphics generator, for generating graphics signal adapted to be overlayed onto the onto the video stream by the video combiner.
